(19) United States
(12) Patent Application Publication
(10) Pub. No.: US 2025/0239400 A1
(43) Pub. Date: Jul. 24, 2025

(54) MULTILAYER ELECTRONIC COMPONENT

(71) Applicant: SAMSUNG ELECTRO-MECHANICS CO., LTD., Suwon-si (KR)

(72) Inventors: Sang Woo KIM, Suwon-si (KR); Seol Ah CHONG, Suwon-si (KR)

(73) Assignee: SAMSUNG ELECTRO-MECHANICS CO., LTD., Suwon-si (KR)

(21) Appl. No.: 18/976,816

(22) Filed: Dec. 11, 2024

(30) Foreign Application Priority Data
Jan. 22, 2024 (KR) 10-2024-0009522

(51) Int. Cl. H01G 4/12; H01G 4/30

(52) U.S. Cl. CPC H01G 4/1227; H01G 4/30

(57) ABSTRACT

A multilayer electronic component includes a body including a dielectric layer and internal electrodes disposed alternately with the dielectric layer; and external electrodes disposed on the body, wherein the dielectric layer includes a plurality of grains and a grain boundary disposed between adjacent grains, wherein, when the number of moles of rare earth elements included in the dielectric layer is defined as MRe and the number of moles of Si is defined as MSi based on 100 moles of Ti, 1.6≤MRe/MSi≤4.0 is satisfied, and wherein, when an average content of Si included in the grain is defined as GSi and a maximum value of a content of Si at the grain boundary is defined as BSi, 2.0≤BSi/GSi is satisfied.

### CROSS-REFERENCE TO RELATED APPLICATION(S)

The application claims the benefit of priority to Korean Patent Application No. 10-2024-0009522 filed on Jan. 22, 2024 in the Korean Intellectual Property Office, the disclosure of which is incorporated herein by reference in its entirety.

### TECHNICAL FIELD

The present disclosure relates to a multilayer electronic component.

### BACKGROUND

A multilayer ceramic component (MLCC), a multilayer electronic component, may be a chip condenser mounted on the printed circuit boards of various electronic products including image display devices such as a liquid crystal display (LCD) and a plasma display panel (PDP), a computer, a smartphone, a mobile phone, or the like, and charging or discharging electricity therein or therefrom.

Such a multilayer ceramic capacitor may be used as a component of various electronic devices, since a multilayer ceramic capacitor may have a small size and high capacitance and may be easily mounted. As electronic devices such as computers and mobile devices have been designed to have a reduced size and a high output, demand for a reduced size and high capacitance of a multilayer ceramic capacitor has also been increased.

To implement miniaturization and high capacitance of a multilayer ceramic capacitor, a thickness of the dielectric layer and internal electrode must be thinned and the number of layers must be increased. However, as a thickness of the dielectric layer decreases, an electric field applied to a dielectric increases at the same operating voltage, such that it may be essential to assure reliability of the dielectric.

### SUMMARY

An embodiment of the present disclosure is to provide a multilayer electronic component having improved reliability.

An embodiment of the present disclosure is to prevent a multilayer electronic component having improved reliability in a harsh environment.

According to an embodiment of the present disclosure, a multilayer electronic component includes a body including a dielectric layer and internal electrodes disposed alternately with the dielectric layer; and external electrodes disposed on the body, wherein the dielectric layer includes a plurality of grains and a grain boundary disposed between adjacent grains, wherein, when the number of moles of rare earth elements included in the dielectric layer is defined as MRe and the number of moles of Si is defined as MSi based on 100 moles of Ti, 1.6≤MRe/MSi≤4.0 is satisfied, and wherein, when an average content of Si included in the grain is defined as GSi and a maximum value of a content of Si at the grain boundary is defined as BSi, 2.0≤BSi/GSi is satisfied.

### BRIEF DESCRIPTION OF DRAWINGS

The above and other aspects, features, and advantages of the present disclosure will be more clearly understood from the following detailed description, taken in combination with the accompanying drawings, in which:

FIG. 1 is a perspective diagram illustrating a multilayer electronic component according to an embodiment of the present disclosure;

FIG. 2 is a cross-sectional diagram taken along line I-I′ in FIG. 1;

FIG. 3 is a cross-sectional diagram taken along line II-II′ in FIG. 1;

FIG. 4 is an exploded diagram illustrating a body in FIG. 1;

FIG. 5 is a diagram illustrating region K1 in FIG. 2;

FIG. 6 is a scanned image obtained using a scanning electron microscope (SEM); and

FIG. 7 is a graph obtained by performing a line profile along line L1 in FIG. 6.

### DETAILED DESCRIPTION

Hereinafter, embodiments of the present disclosure will be described as below with reference to the accompanying drawings.

These embodiments are described in sufficient detail to enable those skilled in the art to practice the invention. It is to be understood that the various embodiments of the invention, although different, are not necessarily mutually exclusive. For example, structures, shapes, and sizes described as examples in embodiments in the present disclosure may be implemented in another embodiment without departing from the spirit and scope of the present disclosure. Further, modifications of positions or arrangements of elements in embodiments may be made without departing from the spirit and scope of the present disclosure. The following detailed description is, accordingly, not to be taken in a limiting sense, and the scope of the present invention are defined only by appended claims, appropriately interpreted, along with the full range of equivalents to which the claims are entitled.

In the drawings, the same elements will be indicated by the same reference numerals. Also, redundant descriptions and detailed descriptions of known functions and elements which may unnecessarily make the gist of the present disclosure obscure will be omitted. In the accompanying drawings, some elements may be exaggerated, omitted or briefly illustrated, and the sizes of the elements do not necessarily reflect the actual sizes of these elements. The terms, “include,” “comprise,” “is configured to,” or the like, of the description, are used to indicate the presence of features, numbers, steps, operations, elements, portions or combination thereof, and do not exclude the possibilities of combination or addition of one or more features, numbers, steps, operations, elements, portions or combination thereof.

In the drawings, the first direction may be defined as a thickness (T) direction, the second direction may be defined as a length (L) direction, and the third direction may be defined as a width (W) direction.

### MULTILAYER ELECTRONIC COMPONENT

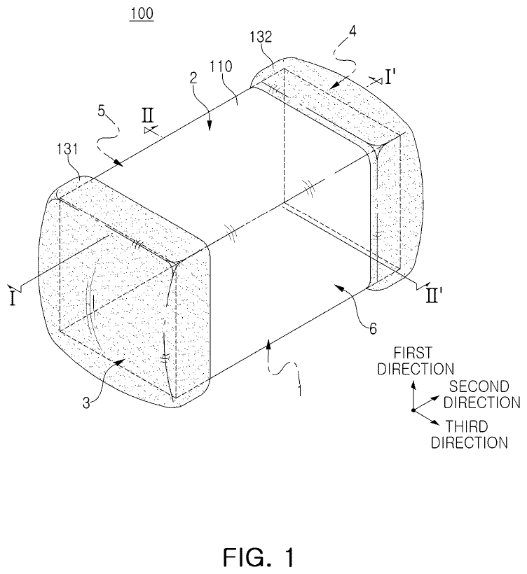

FIG. 1 is a perspective diagram illustrating a multilayer electronic component according to an embodiment.

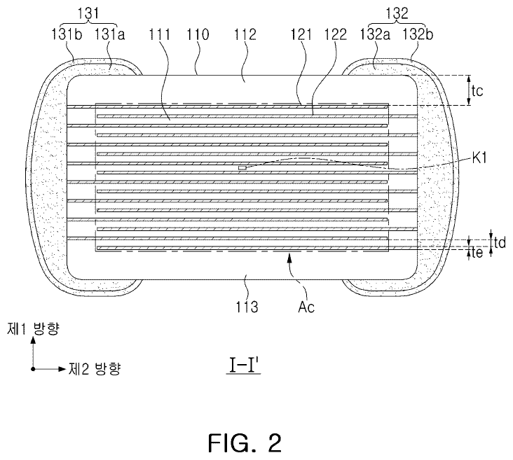

FIG. 2 is a cross-sectional diagram taken along line I-I′ in FIG. 1.

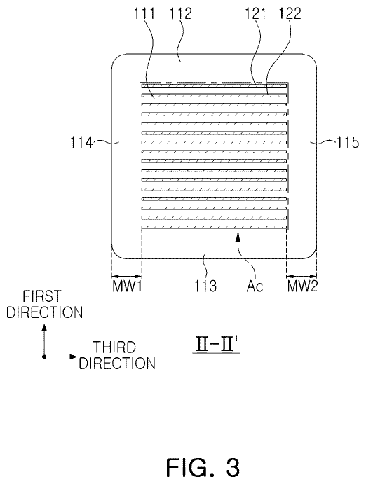

FIG. 3 is a cross-sectional diagram taken along line II-II′ in FIG. 1.

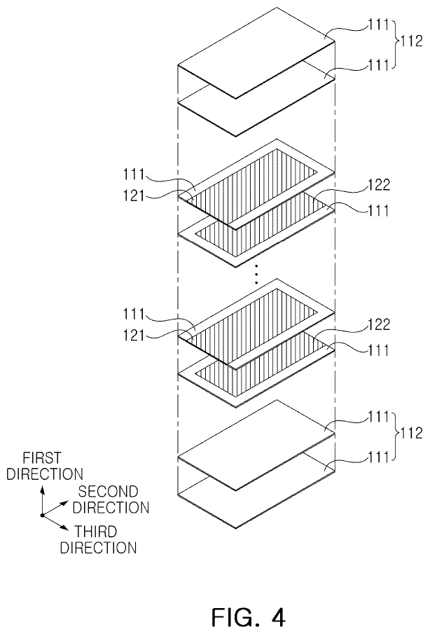

FIG. 4 is an exploded diagram illustrating a body in FIG. 1.

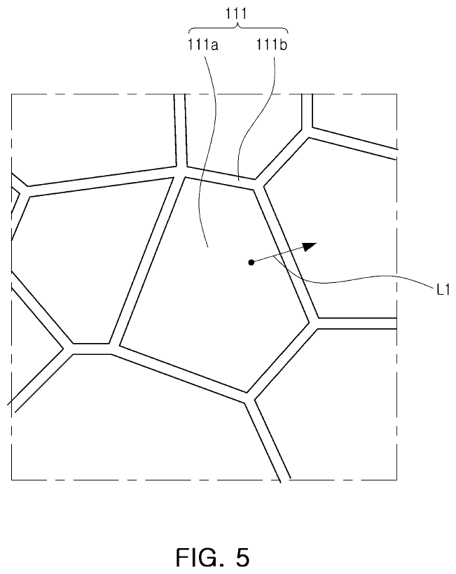

FIG. 5 is a diagram illustrating region K1 in FIG. 2.

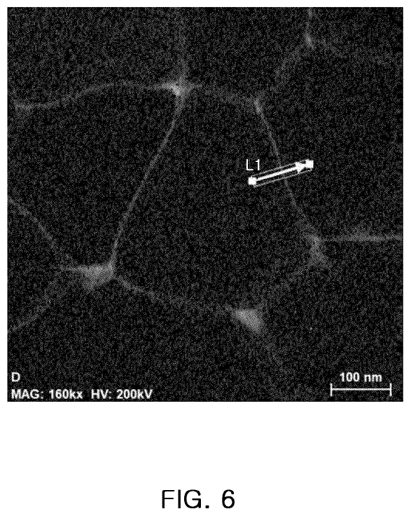

FIG. 6 is a scanned image obtained using a scanning electron microscope (SEM).

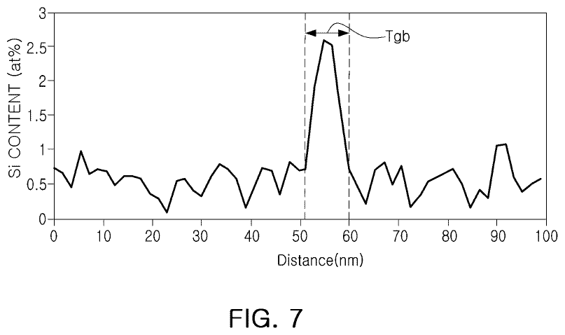

FIG. 7 is a graph obtained by performing a line profile along line L1 in FIG. 6.

Hereinafter, a multilayer electronic component 100 according to an embodiment will be described in greater detail with reference to FIGS. 1 to 7. A multilayer ceramic capacitor will be described as an example of a multilayer electronic component (hereinafter, multilayer ceramic capacitor, MLCC), but an embodiment thereof is not limited thereto, and the multilayer ceramic capacitor may be applied to various multilayer electronic components, such as an inductor, a piezoelectric element, a varistor, or a thermistor.

The multilayer electronic component 100 may include a body 110 including a dielectric layer 111 and internal electrodes 121 and 122 disposed alternately with the dielectric layer; and external electrodes 131 and 132 disposed on the body, the dielectric layer includes a plurality of grains 111a and a grain boundary 111b disposed between adjacent grains, when the number of moles of rare earth elements included in the dielectric layer is defined as MRe and the number of moles of Si is defined as MSi based on 100 moles of Ti, 1.6≤MRe/MSi≤4.0 may be satisfied, and when an average content of Si included in the grain is defined as GSi and a maximum value of a content of Si at the grain boundary is defined as BSi, 2.0≤BSi/GSi may be satisfied.

Hereinafter, each component included in the multilayer electronic component 100 according to an embodiment will be described.

In the body 110, the dielectric layers 111 and the internal electrodes 121 and 122 may be alternately laminated.

The shape of the body 110 may not be limited to any particular shape, but as illustrated, the body 110 may have a hexahedral shape or a shape similar to a hexahedral shape. Due to reduction of ceramic powder included in the body 110 during a firing process or polishing of corners, the body 110 may not have an exactly hexahedral shape formed by linear lines but may have a substantially hexahedral shape.

The body 110 may have the first and second surfaces 1 and 2 opposing each other in the first direction, the third and fourth surfaces 3 and 4 connected to the first and second surfaces 1 and 2 and opposing in the second direction, and the fifth and sixth surfaces 5 and 6 connected to the first and second surfaces 1 and 2 and the third and fourth surfaces 3 and 4 and opposing each other in the third direction. The first surface 1 may be a mounting surface disposed to oppose a substrate when mounted on the substrate.

As the margin region in which the internal electrodes 121 and 122 are not disposed overlaps the dielectric layer 111, a step difference may be formed by a thickness of internal electrodes 121 and 122, and a corner connecting the first surface to the third to fifth surface and/or a corner connecting the second surface to the third to fifth surface may have a shape shrinking toward a center in the first direction of the body 110 when viewed from the first surface or the second surface. Alternatively, due to shrinkage behavior during a process of sintering the body, the corners connecting the first surface 1 to the third to sixth surfaces 3, 4, 5, and 6 and/or the corners connecting the second surface 2 to the third to sixth surfaces 3, 4, 5, and 6 may have a shape shrinking toward a center in the first direction of the body 110 when viewed from the first surface or the second surface. Alternatively, to prevent chipping defects, the corners connecting the surfaces of the body 110 may be rounded by performing a specific process. Accordingly, the corners connecting the first surface to the third to sixth surface and/or the corners connecting the second surface to the third to sixth surface may have a rounded shape.

To prevent the step different caused by the internal electrodes 121 and 122, by forming the margin portions 114 and 115 by cutting the internal electrodes to be exposed to the fifth and sixth surfaces 5 and 6 of the body after lamination, laminating a single dielectric layer or two or more dielectric layers on both sides of the capacitance formation portion Ac in the third direction (width direction), the portion connecting the first surface to the fifth and sixth surfaces and the portion connecting the second surface and the fifth to sixth surfaces may not shrink.

The plurality of dielectric layers 111 forming the body 110 may be in a fired state, and boundaries between adjacent dielectric layers 111 may be integrated with each other such that boundaries therebetween may not be distinct without using a scanning electron microscope (SEM). It may not be necessary to specifically limit the number of laminates of the dielectric layer, and the number of laminates may be determined by considering the size of the multilayer electronic component. For example, the body may be formed by laminating 400 or more layers of the dielectric layer.

The dielectric layer 111 may be formed by preparing a ceramic slurry including ceramic powder, an organic solvent, an additive, and a binder, preparing a ceramic green sheet by coating the slurry on a carrier film drying the slurry, and firing the ceramic green sheet. The ceramic powder is not limited to any particular example as long as sufficient electrostatic capacitance may be obtained. For example, powder based on barium titanate (BaTiO₃) and paraelectric powders based on CaZrO₃ may be used as ceramic powder. The ceramic powder may be one or more of BaTiO₃, (Ba₁₋ₓCaₓ)TiO₃ (0<x<1), Ba(Ti_{1-y}Ca_{y})O₃ (0<y<1), (Ba₁₋ₓCaₓ) (Ti_{1-y}Zr_{y}) O₃ (0<x<1, 0<y<1) and Ba(Ti_{1-y}Zr_{y}) O₃ (0<y<1). The paraelectric powder based on CaZrO₃ may be (Ca₁₋ₓSrₓ) (Zr_{1-y}Ti_{y}) O₃ (0<x<1, 0<y<1).

Accordingly, the dielectric layer 111 may include one or more of BaTiO₃, (Ba₁₋ₓCaₓ) TiO₃ (0<x<1), Ba(Ti_{1-y}Ca_{y}) O₃ (0<y<1), (Ba₁₋ₓCaₓ) (Ti_{1-y}Zr_{y}) O₃ (0<x<1, 0<y<1), Ba(Ti_{1-y}Zr_{y}) O₃ (0<y<1) and (Ca₁₋ₓSrₓ) (Zr_{1-y}Ti_{y}) O₃ (0<x<1, 0<y<1).

The dielectric layer 111 may include BaTiO₃ as a main component.

The dielectric layer 111 may include the plurality of grains 111a and grain boundaries 111b disposed between adjacent grains, and when the number of moles of rare earth elements based on 100 moles of Ti included in the dielectric layer is defined as MRe and the number of moles of Si is defined as MSi, 1.6≤MRe/MSi≤4.0 is satisfied, and when the average content of Si included in the grain is defined as GSi and the maximum value of the content of Si at the grain boundary is defined as BSi, 2.0≤BSi/GSi may be satisfied.

A multilayer ceramic capacitor (MLCC), one of ceramic electronic components, has been designed to have high capacitance and a reduced thickness. To reduce a thickness of the dielectric layer, it may be necessary to prevent charge transfer by reducing a dielectric grain size and to increase grain boundary resistance of the dielectric grain.

The Si element has a large energy bandgap and excellent electrical insulation effect. According to an embodiment, by controlling a ratio of the Si element to the rare earth element included in the dielectric layer 111 and controlling distribution of the Si element in the grain 111a and grain boundary 111b, reliability of the ceramic electronic component 100 may be improved. Accordingly, uniform grains may be assured and grain growth may be prevented, thereby suppressing abnormal grain growth. Also, Si may be positioned at the grain boundary, which may increase an energy barrier, thereby inducing mobility reduction through the hopping or tunneling effect of charge carriers.

When rare earth elements are added to the main component of the barium titanate system (BaTiO₃), rare earth elements may act as a donor by replacing Ba-site, such that the concentration of oxygen vacancies may be reduced, and reliability may improve.

When 1.6≤MRe/MSi≤4.0 is not satisfied or BSi/GSi is less than 2.0, the effect described above may not be insufficient, such that reliability may be reduced.

In this case, an upper limit of BSi/GSi may not be limited to any particular example, and for example, BSi/GSi may be 5.0 or less.

The method of controlling MRe/MSi and BSi/GSi is not limited to any particular example, and MRe/MSi and BSi/GSi may be controlled by, for example, adjusting the composition of the ceramic green sheet, the firing temperature during sintering, and the reducing atmosphere.

Referring to FIG. 5, the grain boundary 111b may surround the grain 111a.

In an embodiment, the mole number (MRe) of rare earth elements based on 100 moles of Ti included in the dielectric layer 111 may be in a range from 0.1 mole to 6.0 mole.

In an embodiment, the mole number (MSi) of Si based on 100 moles of Ti included in the dielectric layer 111 may be in a range from 1.0 mole to 3.5 moles.

The average content GSi of Si included in the grain 111a and a maximum value BSi of the content of Si in the grain boundary 111b are not limited to any particular example.

In an embodiment, the average content GSi of Si included in the grain 111a may be in a range from 0.3 at % to 0.9 at % in atomic percentage.

In an embodiment, the maximum value BSi of the content of Si in the grain boundary 111b may be in a range from 1.5 at % to 3.5 at %.

In an embodiment, the rare earth element included in the dielectric layer 111 may include one or more of Gd, La, Sm, Dy, Tb, Ho, Y, Yb and Sc.

More preferably, the rare earth elements included in the dielectric layer 111 may include Dy and Y.

In an embodiment, the dielectric layer 111 further may include a first subcomponent, and the first subcomponent may be one or more of V, Zr, Mn, Cr, Ti, Ni, Co and W.

A transition metal element may have a variable electron valence (multi-valence), and may lower the firing temperature and may improve the high-temperature withstand voltage properties. Also, when a transition metal element added to the main component of the barium titanate system (BaTiO₃), Ti-site may be substituted. More preferably, the first subcomponent may be V and Mn.

In this case, the dielectric layer 111 may include the first subcomponent in an amount of in a range from 0.5 mole to 3.0 moles based on 100 moles of Ti.

In an embodiment, the dielectric layer 111 may further include a second subcomponent, and the second subcomponent may be Mg. Mg may be a sintering agent element facilitating a sintering process and may form a core-shell structure by controlling grain growth.

In this case, the dielectric layer 111 may include the second subcomponent in an amount in a range from 0.1 mole to 3.0 mole based on 100 moles of Ti.

In an embodiment, when the thickness of grain boundary 111b is defined as Tgb, Tgb may be 8.0 nm or more. Accordingly, the effect of reliability improvement by controlling MRe/MSi and BSi/GSi may be improved.

An upper limit of Tgb is not limited to any particular example. For example, Tgb may satisfy 15.0 nm or less. Accordingly, in an embodiment, Tgb may satisfy 8.0 nm≤Tgb≤15.0 nm.

A content of each element included in the dielectric layer 111 may be analyzed using TEM-EDS to analyze the components in the dielectric grains in a central portion of the chip. Specifically, an analysis sample having a reduced thickness was prepared using a focused ion beam (FIB) device in a region including the dielectric layer in one of cross-sectional surfaces of the body having gone through a sintering process. A damaged layer of the sample having a reduced thickness was removed using Ar ion milling, and thereafter, each component was mapped and quantitatively analyzed in the image obtained using TEM-EDS. In this case, the quantitative analysis graph of each component may be obtained as the mass fraction of each element, which may be represented in mole fraction or atomic fraction.

Also, the multilayer electronic component was pulverized, the internal electrode was removed, the dielectric portion was selected, and the dielectric component may be analyzed using a device such as an inductively coupled plasma optical spectroscopy (ICP-OES) or an inductively coupled plasma mass spectrometer (ICP-MS).

Also, the average content GSi of Si included in the grain 111a, the maximum value BSi of the content of Si in the grain boundary 111b, and the thickness Tgb of the grain boundary 111b may be measured by performing a line profile using a transmission electron microscope (TEM). Specifically, an image as in FIG. 6A may be obtained by scanning a central portion of the cross sections in the first and second directions cut from the center in the third direction of body 110 using a transmission electron microscope (TEM), and a graph as in FIG. 7 may be obtained by measuring the content of Si (at %) as a line profile along the 100 nm line L1 passing vertically between grains. In FIG. 7, the maximum content of Si (at %) may be BSi, the grain average content of Si (at %) may be GSi, and the distance between the points reaching the left and right GSi based on the maximum content of Si (at %) may be the grain boundary thickness Tgb.

Also, BSi, GSi and Tgb may be obtained by measuring the content of Si (at %) as a line profile on ten 100 nm lines passing vertically between grains in FIG. 6, and the average value may be obtained to further generalize the values.

The body 110 may include a capacitance forming portion Ac forming capacitance including the first internal electrode 121 and the second internal electrode 122 disposed in the body 110 and opposing each other with the dielectric layer 111 therebetween, and cover portions 112 and 113 formed in upper and lower portions of the capacitance forming portion Ac in the first direction.

Also, the capacitance forming portion Ac may contribute to forming capacitance of the capacitor, and may be formed by repeatedly laminating the plurality of first and second internal electrodes 121 and 122 with the dielectric layer 111 interposed therebetween.

The cover portions 112 and 113 may include an upper cover portion 112 disposed on an upper portion in the first direction of the capacitance formation portion Ac and a lower cover portion 113 disposed on a lower portion in the first direction of the capacitance formation portion Ac.

The upper cover portions 112 and the lower cover portions 113 may be formed by laminating a single dielectric layer or two or more dielectric layers on the upper and lower surfaces of the capacitance formation portion Ac in the thickness direction, respectively, and may prevent damages to the internal electrode due to physical or chemical stress.

The upper cover portions 112 and the lower cover portions 113 may not include an internal electrode and may include the same material as that of the dielectric layer 111.

That is, the upper cover portions 112 and the lower cover portions 113 may include a ceramic material, for example, a barium titanate (BaTiO₃) ceramic material.

The thickness of the cover portions 112 and 113 may not be limited to any particular example. However, to easily implement miniaturization and high capacitance of the ceramic electronic component, a thickness tc of the cover portions 112 and 113 may be 15 μm or less.

The average thickness tc of the cover portions 112 and 113 may indicate the size in the first direction, and may be an average value of the size in the first direction of the cover portions 112 and 113 measured at five points at an equal distance from the upper portion or the lower portion of the capacitance formation portion Ac.

Also, the margin portions 114 and 115 may be disposed on side surfaces of the capacitance formation portion Ac.

The margin portions 114 and 115 may include a first margin portion 114 disposed on the fifth surface 5 of the body 110 and a second margin portion 115 disposed on the sixth surface 6. That is, the margin portions 114 and 115 may be disposed on both end surfaces of the ceramic body 110 in the width direction.

The margin portions 114 and 115 may indicate a region between both ends of the first and second internal electrodes 121 and 122 and the boundary surface of the body 110 in a cross-section in the width-thickness (W-T) direction of the body 110 as illustrated in FIG. 3.

The margin portions 114 and 115 may basically prevent damages to the internal electrode due to physical or chemical stress.

The margin portions 114 and 115 may be formed by forming the internal electrode by applying conductive paste other than the region in which the margin portion is formed on the ceramic green sheet.

Also, to prevent the step difference caused by the internal electrodes 121 and 122, the margin portions 114 and 115 may be formed by cutting the internal electrode to be exposed to the fifth and sixth surfaces 5 and 6 of the body after lamination, and laminating a single dielectric layer or two or more dielectric layers on both sides of the capacitance formation portion Ac in the third direction (width direction).

The width of the margin portions 114 and 115 may not be limited to any particular example. However, to easily implement miniaturization and high capacitance of the ceramic electronic component, the average width of the margin portions 114 and 115 may be 15 μm or less.

The average width of the margin portions 114 and 115 may indicate the average size MW1 in the third direction of the region in which the internal electrode is spaced apart from the fifth surface and the average size MW2 in the third direction of the region in which the internal electrode is spaced apart from the sixth surface, and may be an average value of the sizes in the third direction of the margin portions 114 and 115 measured at five points at an equal distance in the side surface of the capacitance formation portion Ac.

Accordingly, in an embodiment, the average sizes MW1 and MW2 in the third direction of the region in which the internal electrodes 121 and 122 are spaced apart from the fifth and sixth surfaces, respectively, may be 15 μm or less.

The internal electrodes 121 and 122 may include first and second internal electrodes 121 and 122. The first and second internal electrodes 121 and 122 may be disposed alternately to oppose each other with the dielectric layer 111 included in the body 110 therebetween, and may be exposed to the third and fourth surfaces 3 and 4 of the body 110, respectively.

The first internal electrode 121 may be spaced apart from the fourth surface 4 and may be exposed through the third surface 3, and the second internal electrode 122 may be spaced apart from the third surface 3 and may be exposed through the fourth surface 4. Also, the first internal electrode 121 may be exposed through the third, fifth and sixth surfaces 3, 5, and 6, and the second internal electrode 122 may be exposed through the fourth, fifth and sixth surfaces 4, 5, and 6.

That is, the first internal electrode 121 may not be connected to the second external electrode 132 and may be connected to the first external electrode 131, and the second internal electrode 122 may not be connected to the first external electrode 131 and may be connected to the second external electrode 132. Accordingly, the first internal electrode 121 may be spaced apart from the fourth surface 4 at a predetermined distance, and the second internal electrode 122 may be spaced apart from the third surface 3 by a predetermined distance. Also, the first and second internal electrodes 121 and 122 may be spaced apart from the fifth and sixth surfaces of the body 110.

A conductive metal included in the internal electrodes 121 and 122 may be one or more of Ni, Cu, Pd, Ag, Au, Pt, In, Sn, Al, Ti and alloys thereof, but an embodiment thereof is not limited thereto.

The average thickness td of the dielectric layer 111 may not be limited to any particular example, and may be, for example, 0.1 μm to 10 μm. The average thickness the of the internal electrodes 121 and 122 may not be limited to any particular example, and may be, for example, 0.05 μm to 3.0 μm. Also, the average thickness td of the dielectric layer 111 and the average thickness the of the internal electrodes 121 and 122 may be arbitrarily determined according to desired properties or applications. For example, in the case of a miniature IT electronic component, to implement miniaturization and high capacitance, the average thickness td of the dielectric layer 111 may be 0.4 μm or less, and the average thickness the of the internal electrodes 121 and 122 may be 0.4 μm or less.

The average thickness td of the dielectric layer 111 and the average thickness the of the internal electrodes 121 and 122 may indicate the sizes of the dielectric layer 111 and the internal electrodes 121 and 122 in the first direction, respectively. The average thickness td of the dielectric layer 111 and the average thickness the of the internal electrodes 121 and 122 may be measured by scanning the cross-sections of the body 110 in the first and second directions using a scanning electron microscope (SEM) at 10,000 magnification. More specifically, the average thickness of the dielectric layer 111 may be measured by measuring the thickness at multiple points of the dielectric layer 111, for example, 30 points at equal distances in the second direction. Also, the average thickness of the internal electrodes 121 and 122 may be measured by measuring the thickness at multiple points of one of the internal electrodes 121 and 122, for example, 30 points at an equal distance in the second direction. The 30 points at equal distance may be designated in the capacitance forming portion. Meanwhile, by measuring the average value on 10 dielectric layers 111 and 10 internal electrodes 121 and 122, and the average thickness of the dielectric layer 111 and the average thickness of the internal electrodes 121 and 122 may be further generalized.

The external electrodes 131 and 132 may be disposed on the third and fourth surfaces 3 and 4 of the body 110.

The external electrodes 131 and 132 may be disposed on the third and fourth surfaces 3 and 4 of the body 110, respectively, and may include the first and second external electrodes 131 and 132 connected to the first and second internal electrodes 121 and 122, respectively.

In the embodiment, the ceramic electronic component 100 may have two external electrodes 131 and 132, but the number of the external electrodes 131 and 132 or the shape thereof may be varied depending on the shape of the internal electrodes 121 and 122 or other purposes.

The external electrodes 131 and 132 may be formed of any material having electrical conductivity, such as metal, and a specific material may be determined in consideration of electrical properties and structural stability, and the external electrodes 131 and 132 may have a multilayer structure.

For example, the external electrodes 131 and 132 may include an electrode layer disposed on the body 110 and a plating layer disposed on the electrode layer.

For a more specific example of the electrode layers 131a and 132a, the electrode layers 131a and 132a may be firing electrodes including a conductive metal and glass, or resin electrodes including a conductive metal and resin.

Also, in the electrode layers 131a and 132a, a firing electrode and a resin electrode may be formed in order on the body. Also, the electrode layers 131a and 132a may be formed by transferring a sheet including a conductive metal to the body, or may be formed by transferring a sheet including a conductive metal to the firing electrode.

A material having excellent electrical conductivity may be used as the conductive metal included in the electrode layers 131a and 132a, and is not limited to any particular example. For example, the conductive metal may be one or more of nickel (Ni), copper (Cu), and alloys thereof.

The plating layers 131b and 132b may improve mounting properties. The type of the plating layers 131b and 132b is not limited to any particular example, and may be a plating layer including one or more of Ni, Sn, Pd, and alloys thereof, and may be formed as a plurality of layers.

For a more specific example of the plating layers 131b and 132b, the plating layers 131b and 132b may be Ni plating layers or Sn plating layers, and Ni plating layers and Sn plating layers may be formed in order on the electrode layers 131a and 132a, or Sn plating layers, Ni plating layers, and Sn plating layers may be formed in order. Also, the plating layers 131b and 132b may include a plurality of Ni plating layers and/or a plurality of Sn plating layers.

The size of the ceramic electronic component 100 may not be limited to any particular example.

However, to implement both miniaturization and high capacitance, the thickness of the dielectric layer and the internal electrode may need to be reduced to increase the number of laminated layers. Thus, the effect of improvement in reliability and insulation resistance in the embodiments may be prominent in a ceramic electronic component 100 having a size of 1005 (length×width, 1.0 mm×0.5 mm) or less.

Accordingly, considering manufacturing error and external electrode size, when the length of the ceramic electronic component 100 is 1.1 mm or less and the width is 0.55 mm or less, the effect of reliability improvement in the embodiment may be prominent. Here, the length of the ceramic electronic component 100 may indicate the size in the second direction of the ceramic electronic component 100, and the width of the ceramic electronic component 100 may indicate the size in the third direction of the ceramic electronic component 100.

### Experimental Example

A ceramic green sheet including barium titanate (BaTiO₃) as a main component and yttrium oxide (Y₂O₃), dysprosium oxide (Dy₂O₃), silicon oxide (SiO₂), vanadium oxide (V₂O₅), and magnesium oxide (MgO) as sub-components was prepared. In this case, the sub-components were added to satisfy the content of each element in Table 1 below, and the content of each element in Table 1 below may indicate the number of moles of the corresponding element based on 100 moles of Ti.

The internal electrode paste was printed on the ceramic green sheet, and the ceramic green sheets were laminated and pressed, thereby manufacturing a laminate. Thereafter, a green chip was manufactured by cutting the laminate into unit chip sizes, was primarily calcinated at 400° C. for 12 hours in an air atmosphere, and was secondarily calcinated at 850° C. for 4 hours in an inert gas atmosphere. Thereafter, the body was manufactured by sintering at 1200° C. for 2 hours in a predetermined reducing atmosphere, and performing an oxidation treatment in an O₂ atmosphere. Thereafter, Cu paste was applied to the body, and the body was heat-treated at 700° C. to form an external electrode, thereby manufacturing a sample chip.

BSi, GSi and Tgb were measured by performing a line profile on the cross-sections in the first and second direction cut from a center in the third direction of the body using a transmission electron microscope.

In a high acceleration life test (HALT), a voltage of 100 V was applied to the sample chip for each test number at 150° C., and the time period until insulation resistance became 1/1000 of the initial value was indicated.

TABLE 1

| | | | | | | | | | | HALT |
|---|---|---|---|---|---|---|---|---|---|---|
| Classification | Dy | Y | V | Mn | Si | Mg | MRe/Msi | BSi/GSi | Tgb | (time) |
| Comparative | 1.0 | 0.5 | 0.1 | 0.2 | 1.5 | 1.0 | 1.0 | 1.2 | 5.7 | 12.1 |
| example 1 | | | | | | | | | | |
| Comparative | 0.5 | 1.5 | 0.1 | 0.3 | 2.5 | 1.0 | 1.3 | 4.0 | 6.3 | 15.3 |
| example 2 | | | | | | | | | | |
| Comparative | 2.0 | 1.5 | 0.1 | 0.3 | 0.8 | 1.0 | 4.4 | 2.2 | 4.8 | 4.5 |
| example 3 | | | | | | | | | | |
| Comparative | 1.0 | 0.8 | 0.1 | 0.3 | 1.0 | 1.0 | 1.8 | 1.8 | 7.0 | 13.0 |
| example 4 | | | | | | | | | | |
| Inventive example 1 | 3.2 | 1.0 | 0.1 | 0.3 | 2.0 | 1.0 | 2.1 | 3.0 | 11.8 | 36.5 |
| Inventive example 2 | 2.5 | 2.0 | 0.1 | 0.3 | 1.5 | 1.0 | 3.0 | 2.8 | 12.9 | 41.1 |
| Inventive example 3 | 3.2 | 1.0 | 0.1 | 0.3 | 2.0 | 1.0 | 2.1 | 3.6 | 8.2 | 36.5 |

In comparative example 1, MRe/Msi and BSi/GSi did not satisfy the conditions of the embodiments, and HALT was deteriorated.

In comparative examples 2 and 3, BSi/GSi satisfied the conditions of the embodiments, but MRe/Msi did not satisfy the conditions of the embodiments, such that HALT was deteriorated.

In comparative example 4, MRe/Msi satisfied the conditions of the embodiments, but BSi/GSi did not satisfy the conditions of the embodiments, such that HALT was deteriorated.

In inventive examples 1 to 3, 1.6≤MRe/MSi≤4.0 and 2.0≤BSi/GSi were satisfied, such that HALT was excellent.

Also, as for inventive examples 1 to 3, the thickness of the grain boundary was assured to be greater than that of comparative examples 1 to 4.

According to the aforementioned embodiments, by controlling the ratio of Si to rare earth elements included in the dielectric layer and distribution of Si, reliability of the ceramic electronic component may be improved.

The embodiments do not necessarily limit the scope of the embodiments to a specific embodiment form. Instead, modifications, equivalents and replacements included in the disclosed concept and technical scope of this description may be employed. Throughout the specification, similar reference numerals are used for similar elements.

In the embodiments, the term “embodiment” may not refer to one same embodiment, and may be provided to describe and emphasize different unique features of each embodiment. The above suggested embodiments may be implemented do not exclude the possibilities of combination with features of other embodiments. For example, even though the features described in an embodiment are not described in the other embodiment, the description may be understood as relevant to the other embodiment unless otherwise indicated.

An expression used in the singular encompasses the expression of the plural, unless it has a clearly different meaning in the context.

While the embodiments have been illustrated and described above, it will be configured as apparent to those skilled in the art that modifications and variations could be made without departing from the scope of the present disclosure as defined by the appended claims.

What is claimed is:

1. A multilayer electronic component, comprising:
a body including a dielectric layer and internal electrodes disposed alternately with the dielectric layer; and
external electrodes disposed on the body,
wherein the dielectric layer includes a plurality of grains and a grain boundary disposed between adjacent grains,
wherein, when a number of moles of rare earth elements included in the dielectric layer based on 100 moles of Ti is defined as MRe and a number of moles of Si based on 100 moles of Ti is defined as MSi, 1.6≤MRe/MSi≤4.0 is satisfied, and
wherein, when an average content of Si included in the grain is defined as GSi and a maximum value of a content of Si at the grain boundary is defined as BSi, 2.0≤ BSi/GSi is satisfied.

2. The multilayer electronic component of claim 1, wherein MRe is in a range from 0.1 mole to 6.0 moles.

3. The multilayer electronic component of claim 1, wherein MSi is in a range from 1.0 mole to 3.5 moles.

4. The multilayer electronic component of claim 1, wherein GSi is in a range from 0.3 at % to 0.9 at %.

5. The multilayer electronic component of claim 1, wherein BSi is in a range from 1.5 at % to 3.5 at %.

6. The multilayer electronic component of claim 1, wherein rare earth elements include one or more of Gd, La, Sm, Dy, Tb, Ho, Y, Yb and Sc.

7. The multilayer electronic component of claim 1, wherein rare earth elements include Dy and Y.

8. The multilayer electronic component of claim 1, wherein the dielectric layer includes one or more of BaTiO₃, (Ba₁₋ₓCaₓ) TiO₃ (0<x<1), Ba(Ti_{1-y}Ca_{y}) 03 (0<y<1), (Ba₁₋ₓCaₓ) (Ti_{1-y}Zr_{y}) O₃ (0<x<1, 0<y<1) and Ba(Ti_{1-y}Zr_{y}) O₃ (0<y<1).

9. The multilayer electronic component of claim 1,
wherein the dielectric layer further includes a first subcomponent, and
wherein the first subcomponent is one or more of V, Zr, Mn, Cr, Ti, Ni, Co and W.

10. The multilayer electronic component of claim 9, wherein the dielectric layer includes the first subcomponent in an amount of 0.5 mole or more and 3.0 mole or less based on 100 moles of Ti.

11. The multilayer electronic component of claim 1,
wherein the dielectric layer further includes a second subcomponent, and
wherein the second subcomponent is Mg.

12. The multilayer electronic component of claim 11, wherein the dielectric layer includes the second subcomponent in an amount in a range from 0.1 mole to 3.0 mole based on 100 moles of Ti.

13. The multilayer electronic component of claim 1, wherein, when an average thickness of the grain boundary is defined as Tgb, Tgb is 8.0 nm or more.

14. The multilayer electronic component of claim 13, wherein Tgb satisfies 8.0 nm≤Tgb≤15.0 nm.

15. The multilayer electronic component of claim 1, wherein BSi and GSi satisfy 2.0≤BSi/GSi≤5.0.

16. A dielectric material, comprising:
BaTiO₃-based dielectric grains with a grain boundary therebetween,
wherein a ratio of number of moles of a rare earth elements based on 100 moles of Ti to a number of moles of Si based on 100 moles of Ti in the dielectric material is in a range from 1.6 to 4.0, and a ratio of an average content of Si in the dielectric grains to a maximum value of content of Si at the grain boundary is greater than or equal to 2.0.

17. The dielectric material of claim 16, wherein the number of moles of rare earth elements based on 100 moles of Ti is in a range from 0.1 to 6.0 and the number of moles of Si based on 100 moles of Ti is in a range from 1.0 to 3.5.

18. The dielectric material of claim 16, wherein the average content of Si in the dielectric grains is in a range from 0.3 at % to 0.9 at %.

19. The dielectric material of claim 16, further including a first subcomponent in an amount of 0.5 mole or more and 3.0 mole or less based on 100 moles of Ti,
wherein the first subcomponent is one or more of V, Zr, Mn, Cr, Ti, Ni, Co and W.

20. The dielectric material of claim 16, further including a second subcomponent comprising Mg.
